(19) United States
(12) Patent Application Publication
(10) Pub. No.: US 2015/0212729 A1
(43) Pub. Date: Jul. 30, 2015

(54) Method for Inputting Chinese in Electronic Device

(71) Applicant: Chiu-Huei TENG, Taipei City (TW)

(72) Inventor: Chiu-Huei TENG, Taipei City (TW)

(21) Appl. No.: 14/310,967

(22) Filed: Jun. 20, 2014

(30) Foreign Application Priority Data
Jan. 29, 2014 (TW) 103103534
Mar. 20, 2014 (TW) 103110450

(51) Int. Cl. G06F 3/0488

(52) U.S. Cl. CPC G06F 3/04886

(57) ABSTRACT

A Chinese input method for computing devices is disclosed. The method includes the steps of a) showing a plurality of radical index divisions, wherein each of the radical index divisions has squares which separately represent different radicals; b) selecting one of the squares, which corresponds to a radical of a Chinese character to be input; c) showing a character index division composed of Chinese characters with the same radical as the selected square in the step b); and d) selecting one from the Chinese characters shown in the step c).

### BACKGROUND OF THE INVENTION

1. Technical Field

The invention relates to character input methods, particularly to a Chinese input method for an electronic device.

2. Related Art

After Computing systems appear, to satisfy various users with different languages, input method software have become necessary in computing systems and electronic devices based on computing systems. Modern users have been used to using a computing system or electronic device to make word processing. Character input methods are to allow users to input foreign characters other than English alphabets. Being faster or more convenient to input foreign characters is the most important issue.

Generally speaking, all currently popular Chinese input methods in computing systems, regardless of pronunciation-based input methods or radical-based input, must use an input device, typically a keyboard. Users utilize a keyboard with numbers, Bopomofo characters and/or radicals to input a Chinese character.

With the advance of touchscreen technology in recent years, Chinese input methods are being improved. Besides directly showing Bopomofo characters or radicals on a touchscreen, another improvement is to directly write a Chinese character on a touchscreen for inputting. Such a hand-writing input method has become the fastest and most convenient Chinese input method.

In sum, current Chinese input methods are designed for Chinese-speaking users. They are too difficult for non-Chinese-speaking users. And the hand-writing input method will become unreliable due to hieroglyphics and is more disadvantageous to non-Chinese-speaking users. As a result, a new Chinese input method which has fast inputting ability and is available for non-Chinese-speaking users is a new issue.

### SUMMARY OF THE INVENTION

An object of the invention is to provide a method for inputting Chinese characters in an electronic device, which uses radicals to categorize Chinese characters and provides related words after a Chinese character has been input. Thus Chinese characters can be fast and conveniently input.

To accomplish the above object, the method of the invention includes the steps of: a) showing a plurality of radical index divisions, wherein each of the radical index divisions has squares which separately represent different radicals; b) selecting one of the squares, which corresponds to a radical of a Chinese character to be input; c) showing a character index division composed of Chinese characters with the same radical as the selected square in the step b); and d) selecting one from the Chinese characters shown in the step c).

### BRIEF DESCRIPTION OF THE DRAWINGS

FIG. 1 is a schematic view of the invention used in a computing system;

FIG. 2 is a schematic view of the invention in use;

FIGS. 3a and 3b are another schematic views of the invention in use;

FIG. 4 is still another schematic view of the invention in use;

FIG. 5 is yet another schematic view of the invention in use;

FIG. 6 is an enlarged view of the radical index division of the invention;

FIG. 7 is another enlarged view of the radical index division of the invention; and

FIG. 8 is a flowchart of the invention.

### DETAILED DESCRIPTION OF THE INVENTION

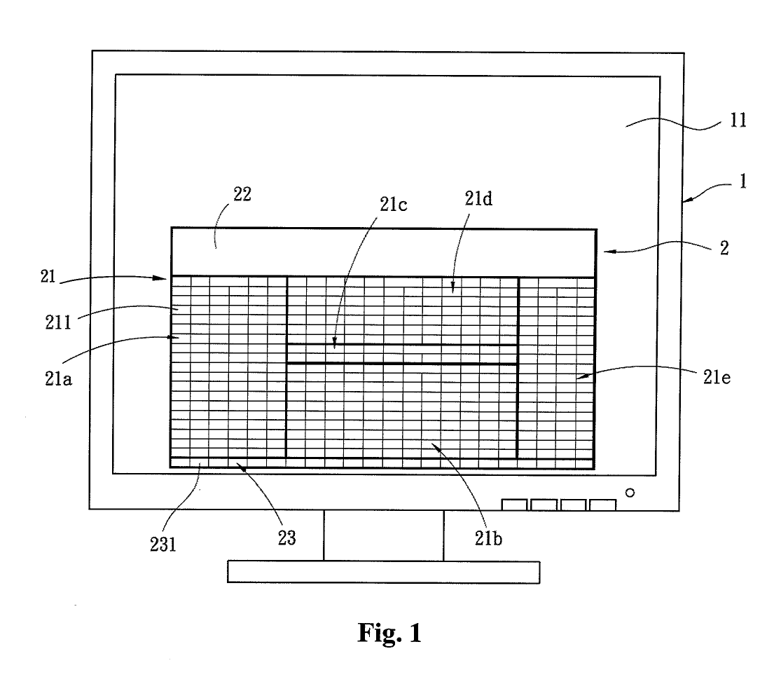

Please refer to FIG. 1, which is a schematic view of the invention used in a computing system. As shown, the Chinese input method of the invention is operated by a software application stored in a memory (not shown) of an electronic device 1. The electronic device 1 in this embodiment is a computing device with a display 11. The electronic device 1 is switched to generate a character input window 2 on the display 11. There are radical index divisions 21 in the character input window 2. In detail, the radical index divisions 21 are composed of a first radical index division 21a, a second radical index division 21 b, a third radical index division 21c, a fourth radical index division 21d and a fifth radical index division 21e.

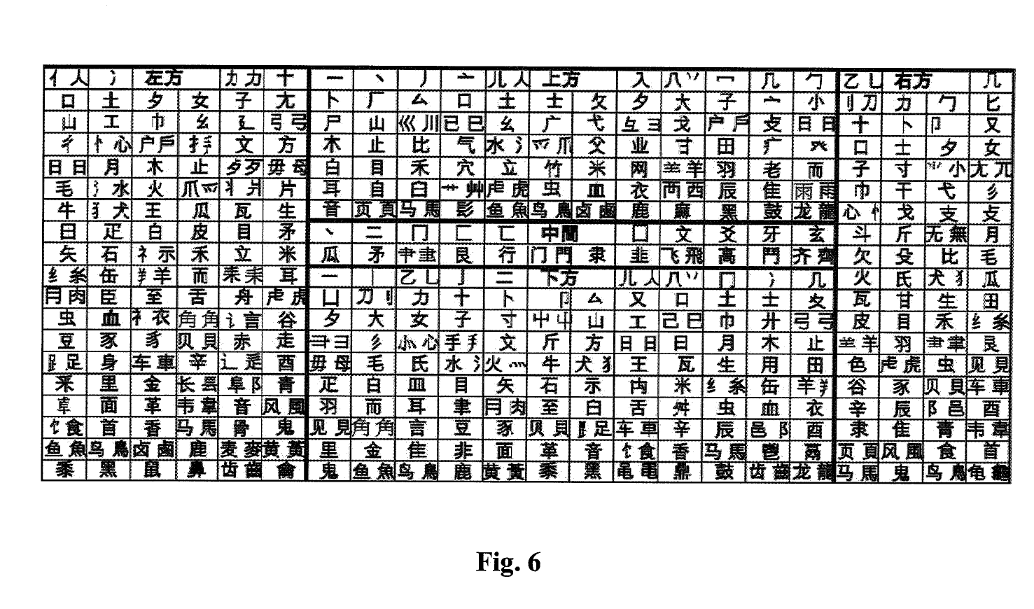

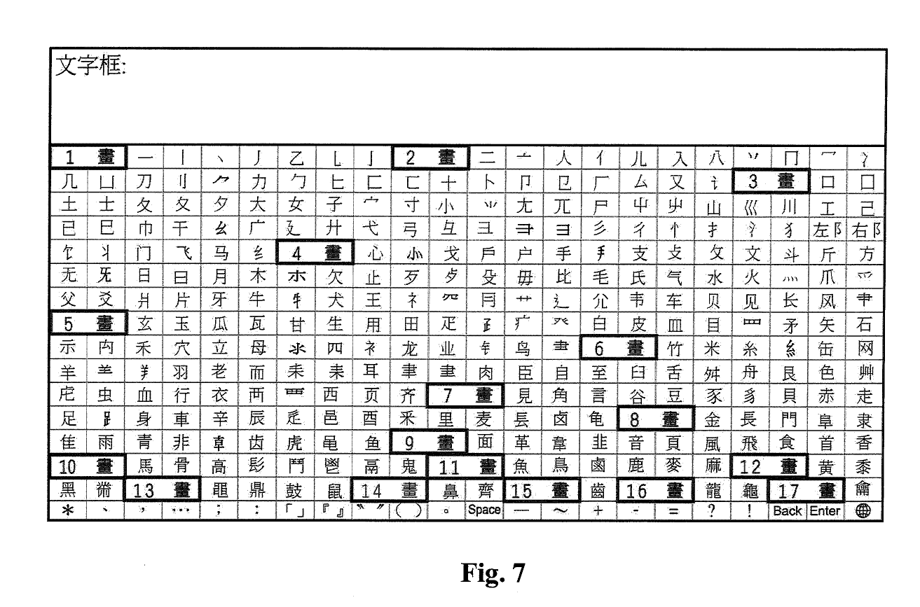

As shown in FIG. 6, the radical index divisions 21a-21e may be expressed in different colors on the display 11 for visual distribution. Each of the radical index divisions 21a-21e includes squares 211. Each square 211 is provided with a Chinese radical and each Chinese radical may be further added with explanation in a foreign language (not shown) such as English for easily understanding to non-Chinese-speaking users. These radicals may be ranked in an order of their stroke numbers as shown in FIG. 7. The expression mode of the radical index divisions 21 can be different from the shown embodiment. There is a character input division 22 in the character input window 2. In the embodiment, the character input division 22 is placed at the top of the radical index division 21. Additionally, there is a function selection division 23 in the character input window 2 and the function selection division 23 is placed at the bottom of the character input window 2. The function selection division 23 has squares 231 with symbols and functions. The software application has a database stored in the memory of the electronic device 1 such as a tablet computer.

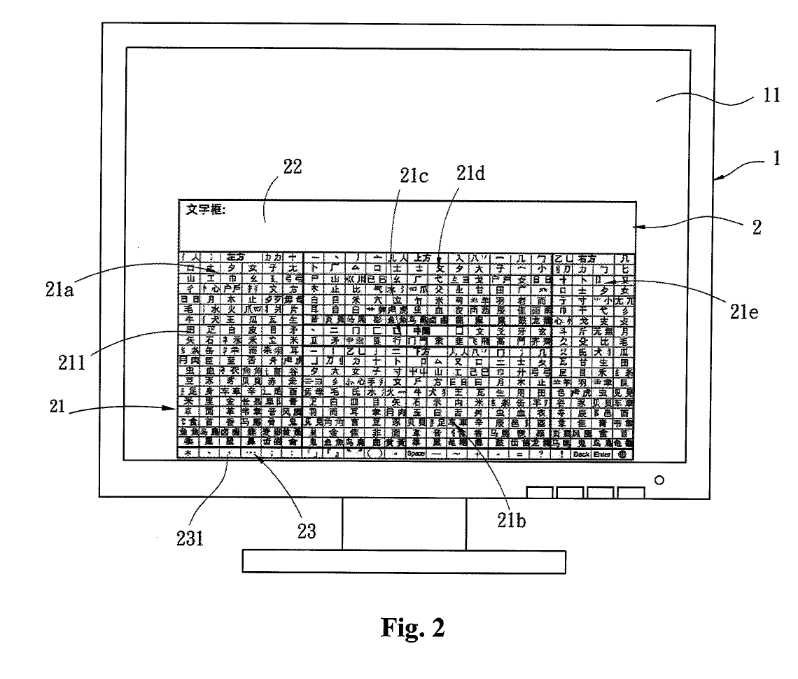

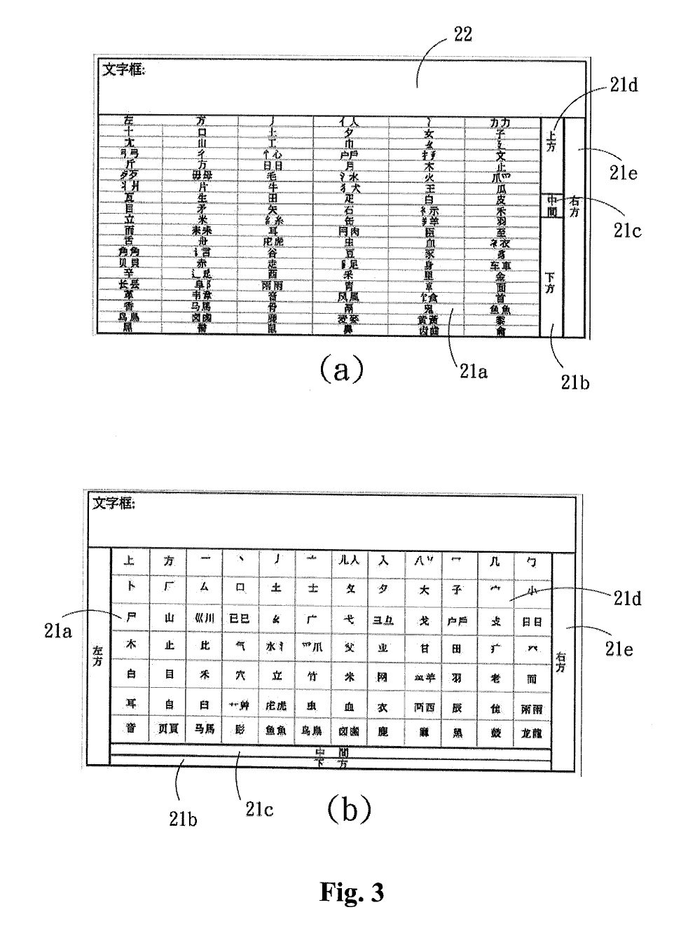

Please refer to FIGS. 2-5, which are schematic views of the invention in use. This embodiment adopts a single radical as an example. As shown in FIG. 2, the Chinese input method of the invention is switched by a user to enter the character input mode and to be expressed on the display 11 of the electronic device 1. The user extracts a radical from a Chinese character to be input and then selects the extracted radical from the first to fifth radical index divisions 21a-21e. For example, when the user selects the first radical index division 21a, the first radical index division 21a will be enlarged and the other radical index division 21b-21e will be shrunk to one side as shown in FIG. 3a. For example again, when the user selects the fourth radical index division 21d, the fourth radical index division 21d will be enlarged and the other radical index division 21b-21e will be shrunk as shown in FIG. 3b. Please refer back to FIG. 3a, when the user has selected a radical square 211 a in the first radical index division 21a, another window will appear on the display 11 to express a character index division 3 for allowing a user to select.

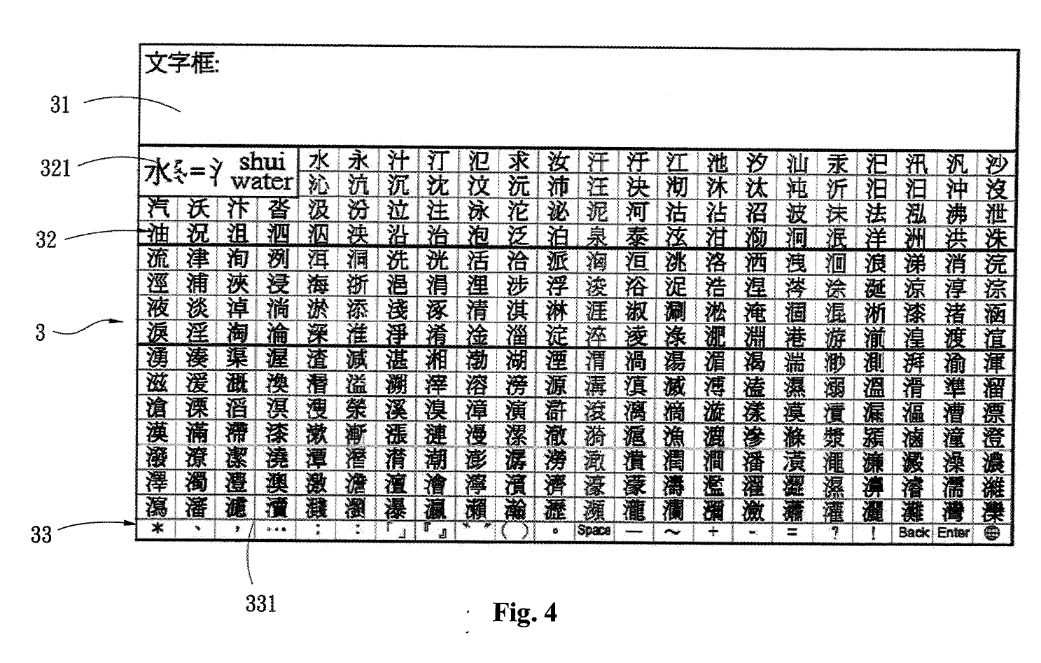

As shown in FIG. 4, the character index division 3 includes a character input division 31, a character aggregation division 32 and a function selection division 33. Characters in the character aggregation division 32 are all ones with the selected radical. The embodiment is an example of traditional Chinese characters. The character aggregation division 32 has a radical expression square 321 for showing the selected Chinese radical, radical variation and explanation in foreign language. Simplified and traditional Chinese characters can be expressed together. The characters are ranked in an order of stroke numbers. Additionally, the system also has a memory function, which can re-rank the characters in an order of using frequency.

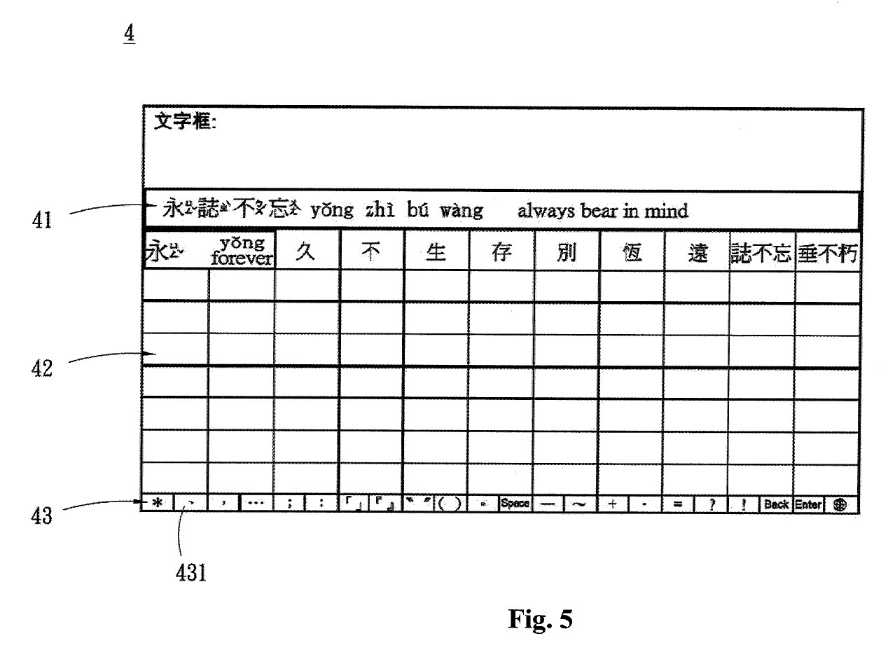

The function selection division 33 is placed at the bottom of the character index division 3 and includes squares 331 which are separately provided with symbols and functions. When a user selects one of the character aggregation division 32, the selected character will be expressed in the character input division 31. After that, the system recognizes the character in the character input division 31, and a word index division 4 will appear on the display 11. As shown in FIG. 5, the word index division 4 includes a character input division 41, a word aggregation division 42 and a function selection division 43. The word aggregation division 42 shows all words containing the selected character. Bopomofo characters, Pinyin characters and explanation in a foreign language will be generated after one of the words has been selected. In this embodiment, the foreign language is English for allowing a user to confirm.

Finally, the function selection division 43 has squares which are separately provided with symbols and functions. Additionally, when the character to be input does not appear, a user can turn back to the first to fifth radical index divisions 21a-21e to reselect another radical. This reselection procedure may be repeated until the wanted character appears.

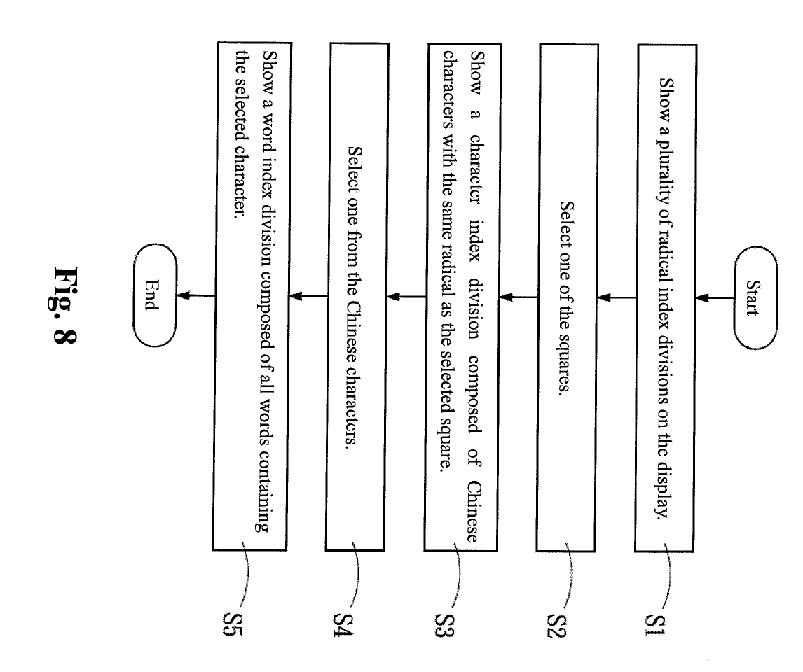

Please refer to FIG. 8, which is a flowchart of the invention. In step S1, show a plurality of radical index divisions 21 on the display 11. Each of the radical index divisions 21 has squares 211, each of which represents a Chinese radical. Additionally, each radical is further provided with explanation in a foreign language. In step S2, select one of the squares 211. In step S3, show a character index division 3 composed of Chinese characters with the same radical as the selected square in the step S2. The character index division 3 includes a character input division 31 and a character aggregation division 32. In step S4, select one from the Chinese characters shown in the step S3. At this time, a frequency of selecting character will be recorded. In step S5, show a word index division composed of all words containing the selected character. Each of the words is further provided with Bopomofo characters, Pinyin characters and explanation in a foreign language. Additionally, the system also records a using frequency of words, which can re-rank the characters in an order of using frequency.

The invention provides a simple and easy Chinese input method. This allows users to fast and conveniently input Chinese characters regardless of Chinese-speaking and non-Chinese-speaking users. Also, the English translation can help Chinese-speaking users to learn English and help non-Chinese-speaking users to learn Chinese.

While the forgoing is directed to a preferred embodiment of the present invention, other and further embodiments of the invention may be devised without departing from the basic scope thereof. As such, the appropriate scope of the invention is to be determined according to the claims.

What is claimed is:

1. A method for inputting Chinese in an electronic device, which is performed on a display, the method comprising the steps of:
a) showing a plurality of radical index divisions, wherein each of the radical index divisions has squares which separately represent different radicals;
b) selecting one of the squares, which corresponds to a radical of a Chinese character to be input;
c) showing a character index division composed of Chinese characters with the same radical as the selected square in the step b); and
d) selecting one from the Chinese characters shown in the step c).

2. The method of claim 1, further comprising the step of:
e) showing a word index division composed of words containing the selected character in the step d).

3. The method of claim 2, wherein the step e) further comprises recording a frequency of the selected word in the step e).

4. The method of claim 2, wherein each of the words is further provided with Bopomofo characters, Pinyin characters and explanation in a foreign language.

5. The method of claim 1, wherein the step d) further comprises recording a frequency of the selected character.

6. The method of claim 1, wherein the radicals in the step a) are separately provided with an explanation in a foreign language.

7. The method of claim 1, wherein the character index division in step c) comprises a character input division, a character aggregation division and a function selection division.

8. The method of claim 2, wherein the word index division in the step e) comprises a character input division, a word aggregation division and a function selection division.
